(19) United States
(12) Patent Application Publication
(10) Pub. No.: US 2016/0012481 A1
(43) Pub. Date: Jan. 14, 2016

(54) OPTIMIZING TARGETED ADVERTISEMENT DISTRIBUTION

(71) Applicant: 140 Proof, Inc., San Francisco, CA (US)

(72) Inventors: Jon Elvekrog, San Francisco, CA (US); John Manoogian, San Francsico, CA (US)

(21) Appl. No.: 14/860,390

(22) Filed: Sep. 21, 2015

Related U.S. Application Data
(63) Continuation of application No. 13/119,938, filed on Mar. 18, 2011, now Pat. No. 8,658,350.
(60) Provisional application No. 61/347,780, filed on May 24, 2010.
(60) Provisional application No. 61/439,778, filed on Feb. 4, 2011.

(51) Int. Cl. G06Q 30/02; G06Q 50/00

(52) U.S. Cl. CPC G06Q 30/0255; G06Q 50/01

(57) ABSTRACT

An iterative method for optimizing targeted advertisement distribution for a social network including a plurality of users, the method including the steps of creating a user summary for a user by extracting persona attributes of a user account, generating a promotion summary for each of a plurality of advertisements, selecting an advertisement for the user based on the similarity between the promotion summary of the advertisement and the user summary, assessing a user reaction to the advertisement, and updating the user summary and promotion summary based on the user reaction.

### CROSS-REFERENCE TO RELATED APPLICATIONS

This application is a continuation of co-pending U.S. patent application Ser. No. 13/113,899, filed 23 May 2011, which claims the benefit of U.S. Provisional Application Nos. 61/347,780 filed 24 May 2010 and 61/439,778 filed 4 Feb. 2011, which are both incorporated in their entirety by this reference.

### TECHNICAL FIELD

This invention relates generally to the social media advertising field, and more specifically to a new and useful method and system for updating social media summaries for content distribution in the social network advertising field.

### BACKGROUND

Digital advertising through websites is an important method for companies to reach customers. To optimize advertising, it would be beneficial to know who are receptive to advertisements and similarly, the products and services being advertised. Not only is it currently a challenge to know the audience that is receptive to advertisements, but in some cases, product and service providers do not know where to focus advertisements due to a lack of knowledge concerning who should be a target audience.

Furthermore, the use of social networking on the internet has seen a surge in use in recent years. Despite an increase in personal information and knowledge of what an individual user is doing, providing personalized content to a user has continued to be a problem. To compound this problem, content streams such as Twitter and Facebook feeds are a growing form of social networking. Unlike traditional web-based advertising, a social stream is filled with diverse and constantly changing information causing many complications in providing targeted content. Not only is the audience not fully understood, but the optimal audience for a promoted media (e.g., advertisement) is also not fully understood.

Thus, there is a need in the social media advertising field to create a new and useful method for providing the most suitable advertisement for a social media user by updating both social media user summaries and the targeted advertisement description during the advertisement campaign. This invention provides such a new and useful method and system.

### BRIEF DESCRIPTION OF THE FIGURES

FIG. 1 is a schematic representation of a preferred embodiment of the invention.

FIG. 2 is a detailed exemplary representation of decaying keywords of a user summary.

FIG. 3 is an illustrated representation of keyword abstractions.

FIG. 4 is a schematic representation of serving promoted content of a preferred embodiment of the invention.

FIG. 5 is a schematic representation of a system for optimized targeted advertisement.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method for Optimized Targeted Advertisement

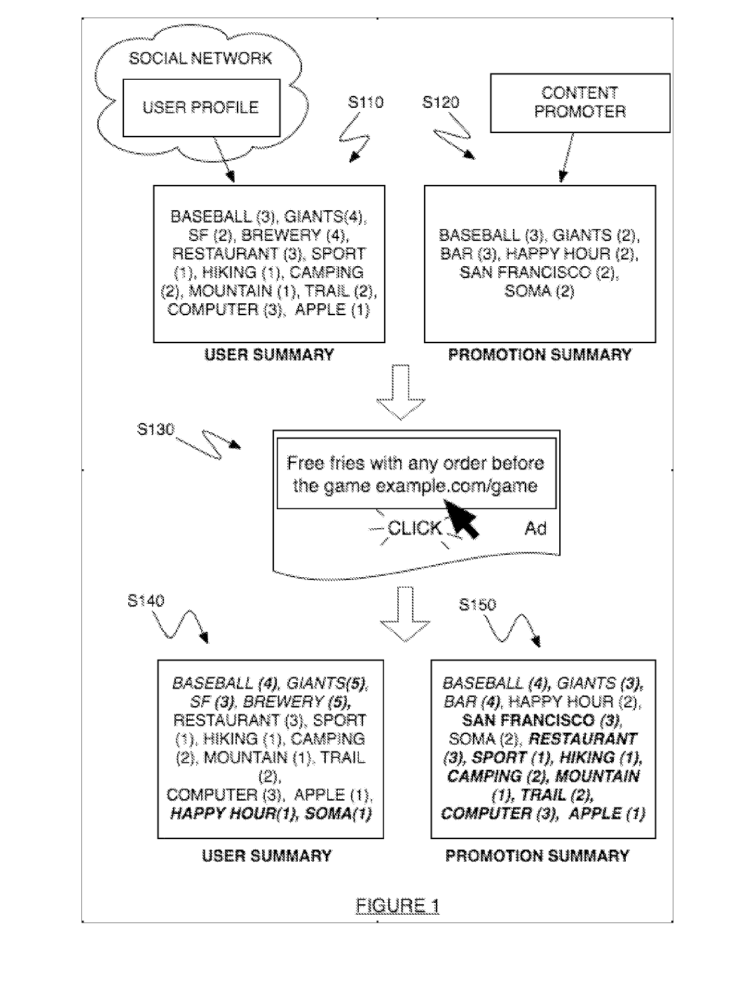

As shown in FIG. 1, a method for optimized targeted advertisement of a preferred embodiment includes creating a user summary for a social media user S110, creating a promotion summary for an advertisement S120, assessing a user action S130, updating the user summary S140, and updating the promotion summary S150. The method functions to adaptively modify user and/or promotion summaries according to actions and behavior of a user. The method preferably enables reinforced learning of characteristics of a user such that promotions can be better targeted at the user. The improved targeting not only improves single advertisement targeting, but overall advertisement targeting for a persona or user. Furthermore, the method preferably optimizes the promotion summary (or target persona) of an advertisement toward receptive users. The outputted promotion summary can preferably be used to better target users in the current advertising campaign, subsequent advertising, or even for general feedback for the advertisers. Similarly, reports concerning the advertisement campaign may be generated from the updated promotion summary and user summaries. The method is preferably implemented in combination with a social media platform. More preferably, the method is used with a social stream (such as a collection of status updates) where users have established social network connections. The method is preferably used for digital advertising, but may alternatively be used for assessing user response to any suitable content such as media or articles. The method is preferably beneficial to optimizing advertising campaigns, but may additionally be used for informing product and service providers who are receptive to their products and services. The method may additionally be used in combination with a method and/or system for creating user-based summaries for content distribution such as U.S. patent application Ser. No. 12/820,074, which is incorporated in its entirety by this reference.

Step S110, which includes creating a user summary for a social media user, functions to create a user data representation or descriptor from the perceived interests and characteristics of the user. The user summary is preferably extracted from implicit persona attributes of a user account and more preferably a content stream. Implicit persona attributes preferably describe characteristics that are apparent through the manner in which the social network is used by the user. A user summary preferably does not rely on the user being an active participant on the social network wherein an active participant describes user that creates content, rates content, interacts with content, and/or performs any suitable action. By having an account with social connections, the user preferably creates a social stream that is populated by content created by the social connections. The information contained within the whole of the social stream preferably includes implicit information from which characteristics of a user may be collected. The implicit information is preferably obtained through the content created by users that the user has decided to follow. The social stream of a user is preferably typically unique in that the user selects which users and entities to form a social network connection with or to follow. For example, a user following several professional baseball players may never actively state in the profile that the user has an interest in baseball, but extracting the implicit information from the user account would preferably indicate that baseball is an interest of the user. The user summary may additionally use explicit information such as content generated by the user or profile information such as location and interests. A large number of users preferably have user summaries created such that the method may be applied to a large population of users of a social network.

The user summary is preferably a collection of weighted keywords. The user summary may alternatively be any suitable data format such as a list of ratings for a standard set list of attributes for which any entity summary may be defined. A keyword is preferably a term or tag that is associated with or assigned to a central concept or piece of information. A group of terms may be associated with a single keyword. These terms preferably do not have to be derived from the same word root. The assignment of a term to a keyword may be algorithmically created or pre-assigned within the system. For example, the terms “Giants”, “golden gate bridge”, “Market St.” may be grouped with the keyword “San Francisco”. Canonical forms of words are preferably additionally recognized. For example, “NYTimes” and “New York Times” would be recognized as the same term and generate an instance of the same keyword. Terms or text may additionally be used to generate multiple keywords. From the earlier example, the term “Giants” may be used to generate an instance of the keyword “San Francisco” and “Baseball”. Keywords may additionally be hierarchical keywords where a keyword may have a parent concept, such as “San Francisco” and “California”. The keywords are preferably derived from content generated by the user and/or the content the user interacts with on a social network. In creating the user summary of weighted keywords, keywords are preferably first identified within content of the social network that the user has interacted with, based on grouping and priority rules keywords are assigned to the user summary, and then weighting is applied to keywords according to how strongly they correlate to, or are affiliated with, a user description (e.g., based on frequency of occurrence). More preferably, the keywords are derived from content of a social network stream. The social network stream may include content the user subscribes (i.e., follows) to and/or content generated by the user. In one variation, the user summary may include a plurality of vector parameters that cooperatively define characteristics of a user. Vectors are preferably different metrics of specifying aspects of user characteristics. Preferably, the vectors include keywords, location, followship (i.e., who the user follows and/or the type of entities the user follows), influence (i.e., number and/or type of followers or friends), mentions (i.e., the number of times the person is discussed by others), demographic, dislikes (e.g., concepts not of interest) and/or any suitable descriptor of a persona. A vector parameter is preferably the variable value for a particular vector. For example, a location vector may have a parameter of ‘San Francisco’ and an interest vector may have a parameter of ‘baseball’. Vectors such as influence may additionally weigh relationships between users. In one variation, the amount of interaction a user has with a second user or users may impact the influence vector of the user. For example, if two users message back and forth frequently then those two may share similar keywords.

Step S120, which includes creating a promotion summary for an advertisement, functions to set up a data representation of what an advertiser or content distributor wants to be targeting when promoting content, forming a basis for the target audience for an advertisement campaign. An advertiser is preferably an entity that wishes to serve promotions to a user, but alternatively the advertiser may be a content provider or any party that wishes to feed targeted content to a user including promoted content, suggested social connections, media, or any suitable form of content. An advertisement summary is preferably a weighted list of keywords substantially similar to a user summary described above, wherein the keywords have an associated importance weight rather than an affiliation weight. The importance weighting is preferably applied to the keyword based on how important an advertiser deems the keyword. The importance weighting preferably influences how well a user summary must match the promotion summary, but may alternately influence how much the keyword may be abstracted or narrowed. The importance weighting may also influence which keywords are added during the promotion summary optimization. Similar to the user summary, the advertisement summary may alternatively be any suitable data format such as a list of ratings for a standard set list of attributes for which any target persona may be defined. The user summary and an advertisement summary preferably have similar formats. Preferably, the format is identical with an advertisement summary preferably composed of a plurality of keyword parameters that cooperatively define targeted characteristics of an advertiser. The advertisement summary may be formed in a variety of ways. As a first variation, the advertiser may select keywords that the advertiser wishes to target for content distribution. These keywords may be bid on by advertisers, and the importance weighting of words may additionally be selected by an advertiser. In a second variation the advertisement summary is preferably formed in substantially the same way as the user summary, by extracting keywords from a social network profile of the advertiser or alternatively from an outside web site. In this variation, the advertisement(s) of the advertiser may be used as the source for keyword extraction. In yet another variation, the advertiser may select a user that functions as prototype user for whom the advertiser wants to target. The advertiser may additionally select a plurality of prototype users. The user summaries of the plurality of prototype users are preferably merged to form a single advertisement summary. The prototype users may be real users or simulated users (fabricated as a model user the advertiser wishes to target). As an additional variation, the advertisement summary is preferably formed by analyzing the followers of an advertiser selected entity. The followers of the entity preferably describe users that have an interest in that entity. The entity may be the social network account of the advertiser, a product, a celebrity (such as a celebrity endorsing an advertised product), a club, or any suitable entity. In another variation, the advertisement summary is preferably selected from a set of predefined personas, wherein the persona is generated from groups of related users. Like the user summaries described above, these predefined personas preferably comprise a plurality of weighted keywords, A stopping metric may be selected in addition to the promotion summary, wherein the advertisement campaign is halted upon meeting the stopping metric. Examples of stopping metrics include a target number of advertisement impressions (e.g. audience size constraint), a budget constraint, a time constraint, or any other suitable constraint. Step S140 may additionally include the sub step of adjusting the promotion summary to accommodate the stopping metric, preferably by abstracting or narrowing the promotion summary keywords or adjusting the keyword weightings. For example, if a large audience size constraint is given, then the persona cannot be too restrictive and vector parameters are preferably more abstract and general. If the audience size constraint is small, then the persona can be more narrow and specific.

Step S130, which includes assessing a user reaction to the advertisement, functions to collect and analyze the reaction of a plurality of users to an advertisement from an advertising campaign. When receiving an advertisement in a social stream, there are a multitude of actions a user may take. Actions made through a social network are preferably gathered and user opinions of the advertisement are interpreted through the actions. One response action may be a sharing action or a redistribution of all or part of the content of the initial advertisement. The redistribution of the advertisement by a user is generally taken as a positive sign that the advertisement effectively received the attention of the user. Another response action may be a referencing action where a user mentions or links to an entity associated with the advertisement. A reference is preferably identified within user created content on the social network. There are various methods and systems that social networks have in place for a user to either mention a user (such as through a tagging system like the use of the “@” symbol followed by a user name) or a concept (such as through a tagging system like the use of “#” hash tags followed by the concept). An entity associated with the advertisement may include the user that posted the advertisement, the user name of the advertising company, a tag referenced in the advertisement, or any way of linking the reference to the advertisement. The reference action may additionally be a direct reply to the advertisement. Other response actions may be advertisement interaction, which could vary depending on the content of the advertisement. A user may click a link, may play a video file, listen to a music file, view a slideshow, interact with interactive media (e.g., a game), install an application, or perform any suitable action made available by the advertisement. Such advertisement interactions are additionally gathered as response actions. Step S130 preferably additionally includes analyzing the quality of the response action S132, which functions to detect how the action response should be interpreted. The action response is preferably categorized as a positive response or a negative response. For example, a positive response may be explicitly positive such as redistribution of the advertisement, click through, following the advertising entity, up votes content, or any suitable positive response to content. Additionally, the positive response may be implicit, such as not down voting content or blocking content. This may be especially pertinent when the user summary shows a history of generating negative responses to content. Likewise, negative responses may be explicitly negative, such as if a user blocks a user, down votes content, deletes content or any suitable negative response to content. Additionally, the negative indicator may be implicit, such as a keyword of the user not being found in the promoted content. The action response is preferably analyzed to produce a quality score, in which a positive quality score indicates that the user had a favorable experience because of the advertisement, and a negative quality score indicates that the user had an unfavorable experience because of the advertisement. The quality of the response action may alternatively be groups assigned to common types of reactions. For example, the quality of an action response may be detected as “found advertisement funny or entertaining”, “found advertisement useful”, “complained of repeated advertisement”, “complained of irrelevant advertisement”, or any suitable category for a response to an advertisement. In creating response actions the user may additionally generate a message. For example, when performing a sharing action or reference action, the user can write their own message that accompanies the resulting content of those actions. User messages preferably are analyzed to determine the quality of the response action. The quality of the action response as indicated through the message is preferably analyzed using natural language processing or any suitable system. Alternatively or additionally to the use of natural language processing, human based computing techniques may be used for categorizing the negative or positive attitudes of users in their responses to advertisements. Human based computing, such as Amazon's crowd-sourcing service Mechanical Turk, uses people as a way of completing a task in line with a computer system. For this step, workers may be used to assign the quality to a response action. In one example, human-based computing techniques may be used when natural language processing is unable to determine the tone of the user. When assessing the response action and the quality of response of a user, the persona or vector parameters of the particular user are preferably linked to those results. A correlation is preferably statistically made between vector parameters and the response action and/or quality of the plurality of users served an advertisement of the advertising campaign.

Step 130 may additionally include the step of retrieving user behavioral action which functions to obtain the user action and context for assessment. Preferably, this is in response to a promotion served to the user, which is preferably served in a manner substantially similar to Step S160. Promoted content that is served to a user preferably appears in the stream of the user, as a graphical or textual advertisement, or in any suitable portion of the interface of a website or application. The operator of the website and/or application can determine when a user performs an action such as following, redistributing (e.g. retweeting), favoriting, tagging (e.g. liking, associating a keyword with the content, bookmarking for later review), referencing, clicking a link (e.g. click-through), viewing the promoted content (such as following a link to a detailed view of the content), any action that characterizes a user preference, or any suitable action. The action is preferably communicated to the operator of the method which may be an advertising company providing an advertising platform for websites and/or applications. In another variation, the retrieval of user behavioral actions may be performed through social network internal monitoring. For example, a social network used as the platform for the social stream may be able to gather data through behavior of users on the website, and through some actions performed through outside applications (such as detecting particular API calls for different content). In this variation, behavior may be tracked outside of promoted content. Interactions with regular social stream content can preferably be tracked and used to update a user summary. Application developers may additionally perform similar tracking. As an additional or alternative variation, link services (such as link shortners) may additionally track link clicks. Such links may be used to funnel users through a controlled service, which can then redirect the user to an end destination. Promoted content may be served to users with unique URL's such that any visit to the URL may be associated with the particular user. The behavioral action is preferably additionally associated with keywords. The keywords are preferably extracted from the content associated with the behavioral action. Preferably, the promoted content has an associated promotion summary, and the keywords of the promoted content can be used. If a second user interacts with the first user's content, then that second user preferably has a user summary or a user summary is generated for the second user or the content.

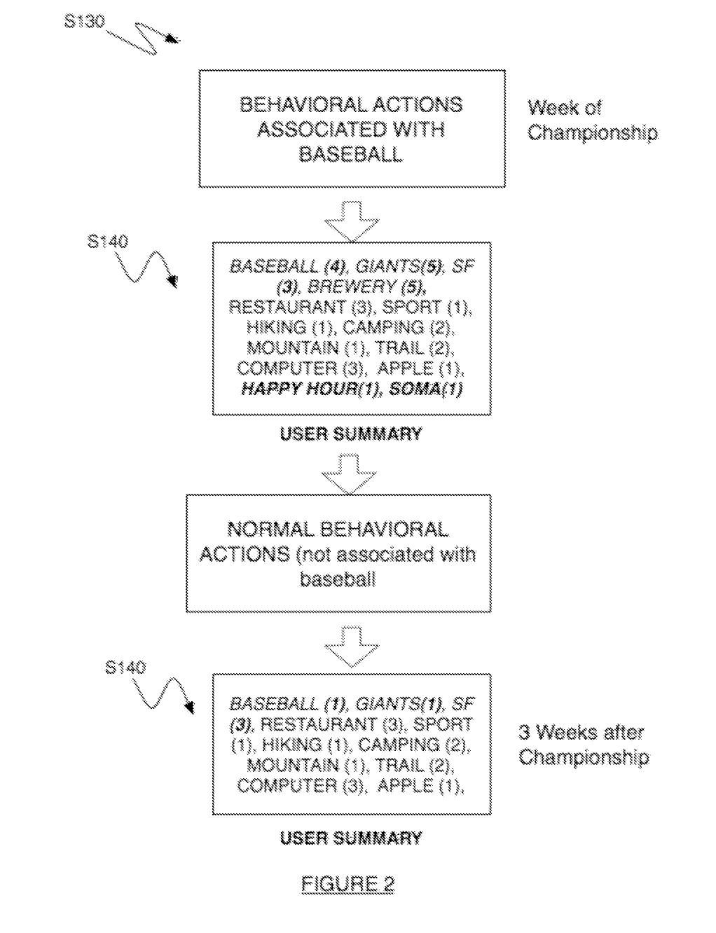

Step S140, which includes updating the user summary, functions to update the list of keywords for a user profile based on the assessment. The user summary is preferably updated as a result of a behavioral action. The keywords are preferably updated by comparing the keywords of the user with the keywords associated with the content or user connected with the behavioral action. The updating of the user summary may incorporate any suitable algorithm such as artificial neural network learning algorithm, and preferably adjusts the user summary keywords. Adjusted keywords are preferably keywords associated with the advertisement, more preferably keywords from the promotion summary. However, the keywords may alternately be derived from user-generated content around the advertisement (e.g. keywords that the user included in a Tweet about the advertisement). If the user response to the content is positive, a keyword or keywords of the user response are preferably promoted in the user summary. A keyword is preferably promoted in a user summary by increasing affiliation weighting, adding the keyword, or any suitable action that increases the association of a keyword with a user. If a keyword is not in a user summary that was associated with a retrieved user action, then the keyword is added to the user summary. If the keywords have affiliation weighting, the affiliation weighting of a keyword may be increased (this may be a an absolute increase or increased in weighting relative to other terms). Keywords that are hierarchically related or related terms may have weighting change in addition or as an alternative to a new keyword being added. Likewise, if a user response is an explicit negative indicator of a keyword, the keyword may be removed from the user summary or have affiliation weighting decreased. If a user response is an implicit negative indicator of a keyword, the weighting of the keywords may be lowered relative to the other terms (this is similar to increasing the relative weighting of keywords with positive indicators). As an additional sub-step, Step S140 may include decaying a keyword of a user summary over time, as shown in FIG. 2. This functions to lessen the weighting or ranking of a keyword after a period of time. This sub-step functions to allow keywords to die out over time. Keywords may even be removed after time, such as when the affiliation weighting of the keyword falls below a predetermined threshold. Similarly, keywords may be magnified when added to enhance temporal interests. As an example of the usefulness of such a sub-step, a user may be very interested in a baseball during a championship, and thus keywords related to the sport may gain a high weighting. After the championship, the user may lose interest in baseball, and by decaying the keywords, promoted content associated with baseball will eventually stop being sent to the user.

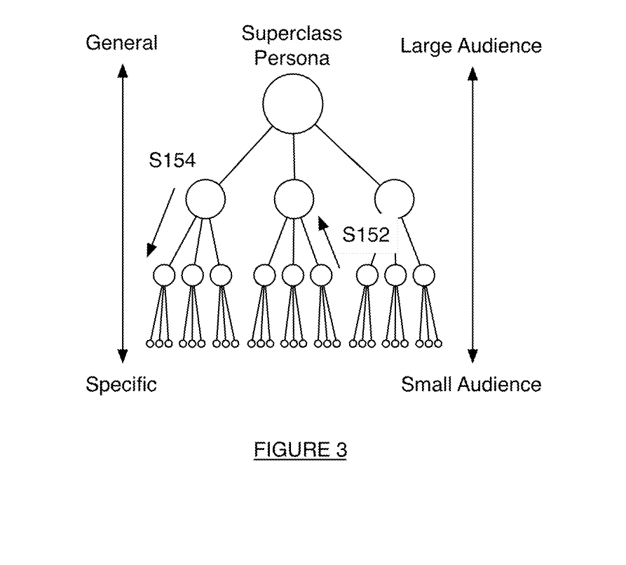

Step S150, which includes updating the promotion summary of an advertisement, functions to modify a promotion summary for improved advertising results. The promotion summary is preferably optimized for the highest positive advertisement results, which is preferably characterized by high probably of response actions and a positive response quality. The promotion summary may alternatively be optimized to satisfy other factors such as audience population, budget constraint, or any suitable constraint. Optimizing of a promotion summary preferably occurs after a sufficient number of user responses have been assessed, but may be optimized dynamically. When optimizing a promotion summary of an advertising campaign, promotion summary-based response patterns are preferably statistically identified. The promotion summary is preferably adjusted to move towards a set of keywords with a positive response, but may alternately be adjusted to move towards a set of keywords that exclude negative responses. In a first variation, the promotion summary is preferably modified by keywords from the user summary, wherein a positive user response preferably promotes a user summary keyword within the promotion summary and a negative user response preferably demotes a user summary keyword within the promotion summary. Keywords are preferably promoted within the promotion summary by increasing the importance weighting or adding the keyword to the summary. Keywords are preferably demoted within the promotion summary by reducing the importance weighting or removing the keyword from the summary. Decaying keywords may additionally be performed as in Step 140. In a second variation, optimizing a promotion summary preferably includes the sub-steps of broadening a promotion summary S152 and/or narrowing a promotion summary S154. Broadening or narrowing a promotion summary preferably functions to move along a promotion summary abstraction as shown in FIG. 3. Broadening a promotion summary S152 preferably functions to make the vector parameters defining a promotion summary more general. This may include abstracting keyword concepts to other terms, adding more similar keywords to attract a larger audience, changing vector parameter limits such as increasing the location range, or any suitable change for the promotion summary to be more generalized. Broadening a promotion summary is preferably performed when a promotion summary is too narrow to satisfy goals such as desired audience population. Broadening may additionally be used to explore other promotion summary characteristics. Narrowing a promotion summary S144 functions to add detail to a promotion summary. Narrowing a promotion summary preferably targets a smaller audience. Narrowing is preferably performed to focus advertising on a group of users with a common promotion summary characteristics that are receptive to an advertisement. Step S150 may additionally add promotion summary groups so that different promotion summary subgroups may be targeted.

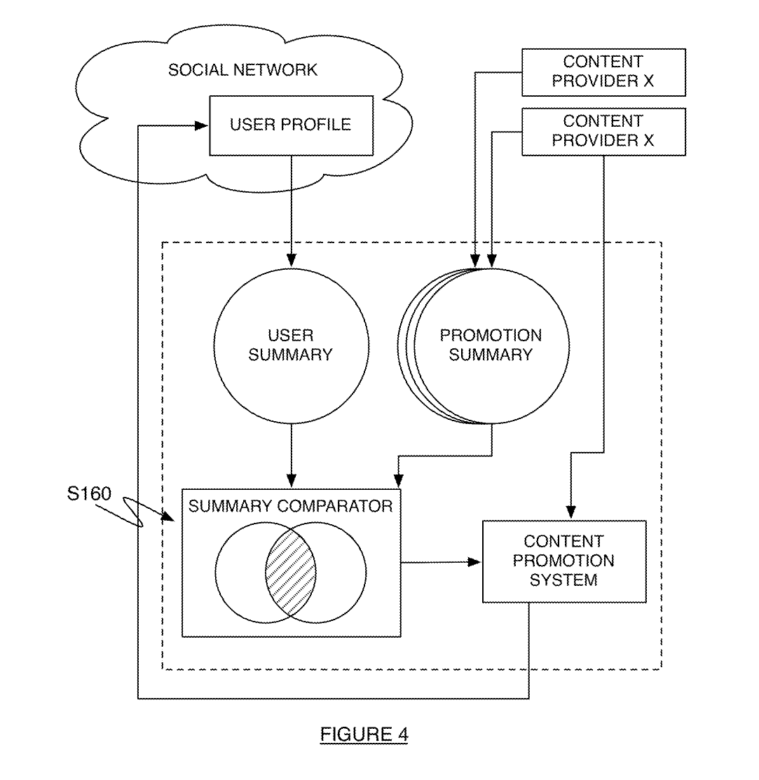

As shown in FIG. 4, the method may additionally include serving promoted content to the user if the similarity score matches set criteria Step S160, which functions to send content to a user when a user summary and an promotion summary are similar to a satisfactory level. The promoted content is preferably selected from a database of content to promote. For example, an advertisement is preferably selected from a list of advertisements of the advertiser for a user. As another example, a user may be selected from list of users to suggest that the first user follow the suggested user. The criteria may be the best match of a number of promotion summaries, which would function to send the most appropriate advertisement to a user. The criteria may alternatively be set to select the promoted content with a promotion summary with a similarity score beyond a set threshold, which would function to send the first advertisement that would be satisfactorily appropriate for the user. A content promoter may additionally individually set the threshold for the similarity score. This functions to enable content promoters to target users with only a particular level of similarity to their list of keywords. Additionally, a promotion summary may have corresponding comparison parameters that must be met before content is selected to be served. Such comparison parameters include the similarity score threshold, a required keyword (e.g. a heavily importance weighted keyword), a keyword that a user must not contain, a combination of keywords, a particular affiliation weighting of a keyword, and/or any suitable criteria. The promoted content is preferably sent to the user through the social network. The promoted content may be displayed on the user profile, within a content stream of the user, or on any suitable portion of the social network. The content selected to be served may additionally rely on additional modules of selection. These additional modules may be used in combination with the user and promotion summary comparison or may be selectively used in place of the user and promotion summary comparison. An additional module may include random selection of content, geographic filters, gender fillers, or any suitable module for selecting promoted content for a user. For example, random selection may be used to narrow the number of possible content, and then a user and promotion summary comparison may be made to select the best content from that group of content.

The method may additionally include iteratively using the optimized promotion summary for serving of advertisements S170, which functions to incrementally focus in on a highly optimized promotion summary for an advertisement, as well as incrementally build a detailed user summary of user preferences. The optimized promotion summary and the new keywords associated with that promotion summary of Step S150 are preferably reintroduced into Step S160 of serving an advertisement. Steps S130, S140, S150 and S160 are preferably repeated any suitable number of times. The iterative process may occur a set number of times, when the optimized promotion summary reaches a substantially steady state, or based on any suitable threshold.

The method may additionally include reporting an optimized promotion summary to a user S180, which functions to inform an advertiser of an optimized target audience. This information is preferably highly valuable, especially to the advertisers that lack knowledge of who is using the product or service advertised. The keywords of the optimized promotion summary are preferably sent to the advertiser in the form of report. The report may additionally include any information on response type of users such as if users commonly quote the advertisement or forward on to other users. Additionally, the reported optimized promotion summary may additionally be used as control interface for the advertiser. The advertiser may be able to adjust particular keywords of an optimized promotion summary. The adjusted keywords are preferably used to define a new promotion summary, which may be used for a new or current advertisement campaign.

### 2. System for Optimized Targeted Advertisement

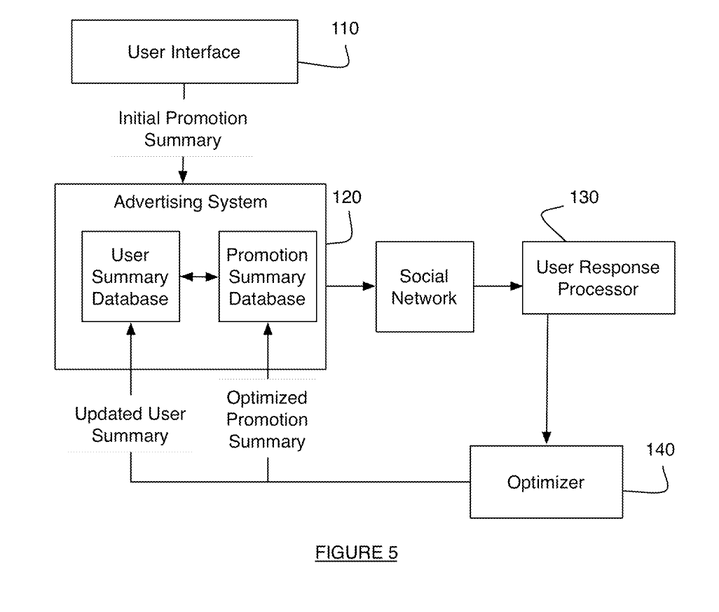

As shown in FIG. 5, a system for optimized targeted advertisement of a preferred embodiment includes an advertising system 120, a user response processor 130, and an optimizer 140. The system functions to optimize a promotion summary for advertising, while building detailed, dynamic summaries of user preferences for users within a social network. The system is preferably implemented for digital advertising on a social network, and more preferably advertising for a content stream. The social network preferably includes a plurality of users with available information for characterizing the users into promotion summaries such as Twitter, Facebook Feed, Google Buzz, Flickr, or any suitable social network. The system may alternatively be used for promotion summary optimization for content distribution in any suitable environment. A promotion summary is preferably characterized by a plurality of vector parameters that are related to characteristics of a person. Preferably the vectors include keywords, location, influence (i.e., number of followers or friends), mentions (i.e., the number of times the person is discussed by others), demographic, and/or any suitable descriptor of a promotion summary. A vector parameter is preferably the variable value for a particular vector. A promotion summary may alternatively be characterized in any suitable format. The system is preferably used to implement the method described above but may be used for any suitable variation.

The advertising system 120 is preferably used for serving advertisements to users of a social network (or any suitable environment). The advertising system 120 preferably matches user summaries with promotion summaries to serve advertisements. For example, a user that has an associated user summary matching that of a promotion summary targeted by an advertisement will preferably be a candidate for receiving the advertisement.

The user response processor 130 preferably analyzes responses of users to advertisements served by the advertising system. The user response processor 130 preferably receives the user response to the advertisement, and processes the user response to determine whether the response is positive or negative. The user response processor 130 may additionally organize the responses based on promotion summary characteristics.

The optimizer 140 preferably adjusts the vector parameters of a promotion summary and a user summary based on the user response processor 130 results. The optimizer 140 preferably adds, removes, or adjusts the keywords (e.g. by adjusting the weighting, abstracting, or narrowing). The vector parameters of the promotion summary are preferably moved toward vector parameters of users with a higher probability of generating positive responses to the advertisement, while the vector parameters of the user summary are preferably adjusted to reflect each user's preferences, as evidenced by the user's response.

The system may additionally include an interface 110 that is preferably used for interfacing with an advertiser or user. The initial conditions of an advertisement campaign are preferably generated through the interface 110. Additionally, the interface 110 may provide feedback of an optimized promotion summary generated by the promotion summary optimizer 140. The advertiser can preferably adjust an optimized promotion summary through the interface 110, which preferably creates a custom optimized promotion summary for use with the advertising system 120.

An alternative embodiment preferably implements the above methods in a computer-readable medium storing computer-readable instructions. The instructions are preferably executed by computer-executable components integrated with an advertising system. The advertising system is preferably persona driven and preferably integrated with a social network with user content streams. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for targeted advertisement distribution for a social network including a plurality of users, the method comprising the steps of:
a) creating a user summary for a user by extracting persona attributes of a user account, the user summary including a plurality of keywords, wherein each keyword is associated with an affiliation weight;
b) generating a promotion summary for each of a plurality of advertisements, each promotion summary including a plurality of keywords, wherein each keyword is associated with an importance weight;
c) selecting an advertisement for the user based on the similarity between the promotion summary for the advertisement and the user summary;
d) assessing a user action in response to the advertisement;
e) updating the user summary based on the user action assessment;
f) updating the user summary based on time dependence;
g) updating the promotion summary based on the user action assessment;
h) iterating through steps c) to g) until a predetermined metric is met.
